(19) United States
(12) Patent Application Publication
(10) Pub. No.: US 2020/0279307 A1
(43) Pub. Date: Sep. 3, 2020

(54) VEHICLE RIDE-SHARING SUPPORT SYSTEM AND USER TERMINAL APPARATUS

(71) Applicant: HONDA MOTOR CO., LTD., Tokyo (JP)

(72) Inventors: Kuniaki Matsushima, Wako-shi (JP); Isao Uematsu, Wako-shi (JP); Kenichi Kobayashi, Wako-shi (JP)

(21) Appl. No.: 16/801,890

(22) Filed: Feb. 26, 2020

(30) Foreign Application Priority Data
Mar. 1, 2019 (JP) 2019-037357

(51) Int. Cl. G06Q 30/02; G01C 21/34; G06Q 50/30; G06Q 10/02

(52) U.S. Cl. CPC G06Q 30/0284; G01C 21/3453; G06Q 10/02; G06Q 50/30; G01C 21/3438

(57) ABSTRACT

A vehicle ride-sharing support system which supports matching between a user and a vehicle for ride-sharing includes a condition information acquiring unit acquiring desired condition information, from a user terminal apparatus, the desired condition information including a desired location and a desired time slot which are desired by the user, a reservation information acquiring unit acquiring and storing a reservation accepting record indicating a reserved location, a reserved date and a reserved time slot for each of matching reservation requests transmitted from the user terminal apparatus, and a difficulty level calculating unit calculating, on a basis of the stored past reservation accepting record, an index value of an index representing a difficulty level of achievement of the matching for each predetermined time slot including the desired time slot for each of predetermined locations in an area within a predetermined distance range including the desired location.

### INCORPORATION BY REFERENCE

The present application claims priority under 35 U.S.C. § 119 to Japanese Patent Application No. 2019-037357 filed on Mar. 1, 2019. The content of the applications is incorporated herein by reference in its entirety.

### BACKGROUND OF THE INVENTION

### Field of the Invention

The present invention relates to a vehicle ride-sharing support system which supports matching between a plurality of users who intend to move to destinations by utilizing vehicles which allow ride-sharing, and vehicles for ride-sharing, and a user terminal apparatus.

### Description of the Related Art

A car ride-sharing support method is known in which a driver and a person who desires to utilize a vehicle are matched from traveling schedule information on a vehicle and the driver, and movement schedule information on the person who desires to utilize a vehicle (such as desired time for riding in a vehicle, a desired location for riding in a vehicle and a destination), and the driver and the person who desires to utilize a vehicle are notified of a place and time for meeting (see Japanese Patent Laid-Open No. 2002-140399).

In the above-described car ride-sharing support method in related art, for example, in a case where traveling schedule time of the vehicle indicated by the traveling schedule information does not match the desired time for riding in a vehicle indicated by the movement schedule information, or in a case where places through which the vehicle passes on a traveling schedule route of the vehicle do not include the desired location for riding in a vehicle indicated by the above-described movement schedule information, ride-sharing matching (matching) for the vehicle is not achieved for the person who desires to utilize a vehicle.

However, it is often convenient for the person who desires to utilize a vehicle to utilize a vehicle for ride-sharing by performing adjustment, if ride-sharing is achieved by slightly adjusting the desired time for riding in a vehicle or the desired location for riding in a vehicle. That is, there is a demand from the person who desires to utilize a vehicle, to know at which place or in which time slot matching is more likely to be achieved.

The present invention has been made in view of the above-described circumstances, and is directed to increase a possibility of achievement of matching between a user who desires ride-sharing of a vehicle and a vehicle for ride-sharing by encouraging the user to adjust desired time for riding in a vehicle or a desired place for riding in a vehicle.

### SUMMARY OF THE INVENTION

One aspect of the present invention is a vehicle ride-sharing support system which supports matching between a user who desires ride-sharing of a vehicle and a vehicle for ride-sharing, the vehicle ride-sharing support system including a condition information acquiring unit configured to acquire desired condition information from a user terminal apparatus utilized by the user, the desired condition information including a desired location for riding in a vehicle and a desired time slot for riding in a vehicle, the desired location and the desired time slot being desired by the user regarding a vehicle for ride-sharing, a reservation information acquiring unit configured to acquire and store a reservation accepting record for each matching reservation request, the reservation accepting record being indicative of the following indicated in a matching reservation request: a reserved location for riding in a vehicle; a reserved date for riding in a vehicle; and a reserved time slot for riding in a vehicle, the matching reservation request being transmitted from the user terminal apparatus of the user for requesting reservation of the matching, and a difficulty level calculating unit configured to calculate an index value of an index representing a difficulty level of achievement of the matching for each predetermined time slot including the desired time slot for riding in a vehicle for each of predetermined locations in an area within a predetermined distance range including the desired location for riding in a vehicle, on the basis of the stored past reservation accepting record.

According to another aspect of the present invention, the index is the number of persons who make reservations while the predetermined location is set as the reserved location for riding in a vehicle, and the predetermined time slot is set as the reserved time slot for riding in a vehicle, in a past predetermined period.

According to another aspect of the present invention, the index is an average number of persons who make reservations per day of the number of persons who make reservations while the predetermined location is set as the reserved location for riding in a vehicle, and the predetermined time slot is set as the reserved time slot for riding in a vehicle, in the past predetermined period.

According to another aspect of the present invention, the index is a proportion of the number of persons who make reservations while the predetermined time slot is set as the reserved time slot for riding in a vehicle to persons who make reservations while the predetermined location is set as the reserved location for riding in a vehicle, in the past predetermined period or at a past predetermined date.

Another aspect of the present invention is a vehicle ride-sharing support system which supports matching between a vehicle for ride-sharing and a user who desires ride-sharing of a vehicle, the vehicle ride-sharing support system including a condition information acquiring unit configured to acquire desired condition information from a user terminal apparatus utilized by the user, the desired condition information including a desired location for riding in a vehicle and a desired time slot for riding in a vehicle, the desired location and the desired time slot being desired by the user regarding a vehicle for ride-sharing, an achievement information acquiring unit configured to acquire and store a matching achievement record indicating a location where the user rides in a vehicle, a date at which the user rides in a vehicle, and a time slot in which the user rides in a vehicle for each vehicle for ride-sharing for which the matching is achieved, and a difficulty level calculating unit configured to calculate, on the basis of the stored matching achievement record, an index value of an index representing a difficulty level of achievement of the matching for each predetermined time slot including the desired time slot for riding in a vehicle for each of predetermined locations in an area within a predetermined distance range including the desired location for riding in a vehicle.

According to another aspect of the present invention, the index is a matching achievement probability indicating a proportion of the number of days in which the matching is achieved in the predetermined time slot, at the predetermined location, within the predetermined period, to the number of days in the past predetermined period.

According to another aspect of the present invention, the vehicle ride-sharing support system includes an index value output unit configured to output the calculated index value for each predetermined time slot for each of the predetermined locations to the user terminal apparatus of the user, from which the desired condition information is acquired.

Another aspect of the present invention is the user terminal apparatus which receives the calculated index value from the above-described vehicle ride-sharing support system, the user terminal apparatus including an input apparatus configured to accept input from the user, a display apparatus, and a processing apparatus, the processing apparatus displaying a map in which display in accordance with the calculated index value or a magnitude of the index value is indicated at a position corresponding to the predetermined location, at the display apparatus in response to one of the predetermined time slots being input from the user.

Still another aspect of the present invention is the user terminal apparatus which receives the calculated index value from the above-described vehicle ride-sharing support system, including an input apparatus configured to accept input from the user, a display apparatus, and a processing apparatus, the processing apparatus displaying a diagram indicating transition of the calculated index value along the predetermined time slots at the predetermined location, at the display apparatus in response to one of the predetermined locations being input from the user.

According to another aspect of the present invention, the above-described vehicle ride-sharing support system further includes an index value output unit configured to generate map information in which display in accordance with the index value calculated for each of the predetermined locations or a magnitude of the index value for the one predetermined time slot is displayed at positions on a map respectively corresponding to the predetermined locations, and output the generated map information to the user terminal apparatus of the user, from which the desired condition information is acquired.

According to another aspect of the present invention, the above-described vehicle ride-sharing support system further includes an index value output unit configured to generate transition information for generating a diagram indicating transition of the index value calculated for the one predetermined location for each predetermined time slot, and output the transition information to the user terminal apparatus of the user, from which the desired condition information is acquired.

According to aspects of the present invention, it is possible to increase a possibility of achievement of matching between a user and a vehicle for ride-sharing by encouraging the user who desires ride-sharing of a vehicle to adjust desired time for riding in a vehicle and a desired location for riding in a vehicle.

### BRIEF DESCRIPTION OF THE DRAWINGS

FIG. 1 is a diagram illustrating an example of a scene in which a vehicle ride-sharing support system according to an embodiment of the present invention is utilized;

FIG. 2 is a diagram illustrating an example of a configuration of a vehicle ride-sharing support system of the present invention;

FIG. 3 is a diagram illustrating an example of a configuration of a user terminal apparatus to be used along with the vehicle ride-sharing support system of the present invention;

FIG. 4 is a diagram illustrating an example of a display screen of an index value map displayed at the user terminal apparatus using an index value output by the vehicle ride-sharing support system of the present invention;

FIG. 5 is a diagram illustrating an example of a display screen of an index value transition graph displayed at the user terminal apparatus using the index value output by the vehicle ride-sharing support system of the present invention;

FIG. 6 is a flowchart illustrating procedure of operation of the vehicle ride-sharing support system of the present invention; and

FIG. 7 is a flowchart illustrating procedure of operation of the user terminal apparatus to be used along with the vehicle ride-sharing support system of the present invention.

### DETAILED DESCRIPTION OF THE PREFERRED EMBODIMENTS

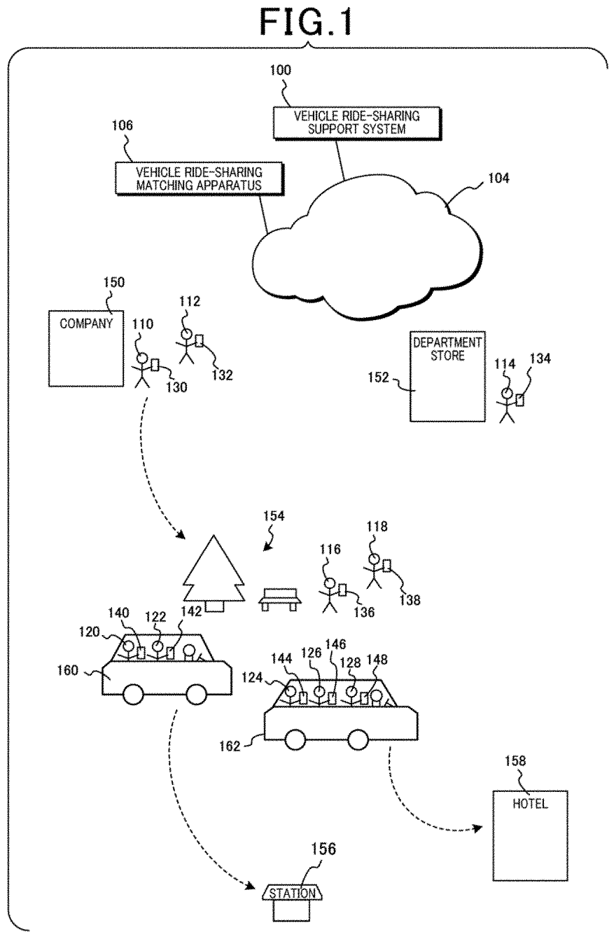

An embodiment of the present invention will be described below with reference to the drawings. FIG. 1 is a diagram illustrating an example of a scene in which a vehicle ride-sharing support system 100 according to an embodiment of the present invention is utilized. The vehicle ride-sharing support system 100 according to the present embodiment is realized as one apparatus, for example, as a server. However, this is merely an example, and the vehicle ride-sharing support system 100 can be configured with, for example, a plurality of apparatuses which are connected to each other so as to be able to perform communication with each other.

The vehicle ride-sharing support system 100 is connected to mobile terminals 130, 132, 134, 136, 138, 140, 142, 144, 146 and 148 (hereinafter, also referred to as a mobile terminal 130, or the like), which are user terminal apparatuses of users 110, 112, 114, 116, 118, 120, 122, 124, 126 and 128 (hereinafter, also referred to as a user 110, or the like), so as to be able to perform communication. Here, communication between the vehicle ride-sharing support system 100 and the mobile terminal 130, or the like, can be performed, for example, indirectly via a network 104 which is the Internet, or directly without involving the network 104.

This vehicle ride-sharing support system 100 supports matching (hereinafter, also referred to as matching) between a vehicle for ride-sharing provided for ride-sharing and a user who desires ride-sharing of a vehicle in cooperation with the mobile terminal 130, or the like, of the user 110, or the like, or alone, to increase a possibility of achievement (a likelihood of achievement, a probability of achievement) of matching.

The vehicle ride-sharing support system 100 is connected to a vehicle ride-sharing matching apparatus 106 via, for example, the network 104 so as to be able to perform communication. However, this is merely an example, and the vehicle ride-sharing support system 100 may be directly connected to the vehicle ride-sharing matching apparatus 106 without involving the network 104. Alternatively, the vehicle ride-sharing support system 100 may include functions of the vehicle ride-sharing matching apparatus 106.

The vehicle ride-sharing matching apparatus 106 is directly connected to or indirectly via the network 104 to the mobile terminal 130, or the like, of the user 110, or the like, so as to be able to perform communication, and performs matching between the user 110, or the like, and a vehicle for ride-sharing (that is, matching of the user 110, or the like, to a vehicle for ride-sharing) in accordance with related art. Specifically, the vehicle ride-sharing matching apparatus 106 receives a matching reservation request for requesting reservation of matching with a vehicle for ride-sharing from the user 110, or the like, who desires ride-sharing of a vehicle via the mobile terminal 130, or the like. This matching reservation request can include a reserved location for riding in a vehicle, a reserved date for riding in a vehicle, a reserved time slot for riding in a vehicle and a reserved location for getting off a vehicle. Here, the reserved location for riding in a vehicle is a location where a user is scheduled to ride in a vehicle for ride-sharing, presented by the user as a condition for matching with a vehicle for ride-sharing (matching condition), and the reserved date for riding in a vehicle is a date at which the user is scheduled to ride in the vehicle for ride-sharing as part of the above-described matching condition. Further, the reserved time slot for riding in a vehicle is a time slot in which the above-described user is scheduled to ride in the above-described vehicle for ride-sharing as part of the matching condition presented by the user, and the reserved location for getting off a vehicle is a location where the user is scheduled to get off the vehicle after riding in the above-described vehicle for ride-sharing, as part of the above-described matching condition.

Further, the vehicle ride-sharing matching apparatus 106 acquires vehicle information (information such as a route on which a vehicle can travel, a date at which a vehicle can travel, a time slot in which a vehicle can travel, the number of persons who can ride in a vehicle, and vehicle identification information such as registration number of a car registration plate) for the vehicle for ride-sharing from a vehicle owner, or the like, who provides the vehicle for ride-sharing. Then, the vehicle ride-sharing matching apparatus 106 matches the user 110, or the like, for whom, for example, the reserved location for riding in a vehicle, the reserved location for getting off a vehicle, the reserved date for riding in a vehicle and the reserved time slot for riding in a vehicle match the route on which a vehicle can travel, the date at which a vehicle can travel and the time slot in which a vehicle can travel, with the vehicle for ride-sharing, on the basis of the matching reservation request acquired from the user 110, or the like, and the vehicle information acquired from a vehicle provider. Further, the vehicle ride-sharing matching apparatus 106 notifies the mobile terminal 130, or the like, of the user 110, or the like, for whom the above-described matching is achieved and the vehicle provider of the vehicle for ride-sharing relating to the matching of information indicating that the above-described matching is achieved, and enables the user 110, or the like, to ride in the matched vehicle for ride-sharing.

Further, when the vehicle ride-sharing matching apparatus 106 receives the above-described matching reservation request, the vehicle ride-sharing matching apparatus 106 generates a reservation accepting record for each matching reservation request, the reservation accepting record being composed of the following indicated in the matching reservation request: the reserved location for riding in a vehicle; the reserved date for riding in a vehicle; the reserved time slot for riding in a vehicle; and the reserved location for getting off a vehicle. Then, the vehicle ride-sharing matching apparatus 106 stores reservation result information including the generated reservation accepting record.

In the example in FIG. 1, it is assumed that the vehicle ride-sharing matching apparatus 106 has already stored the reservation result information including the above-described reservation accepting records for the past one month. Here, the reservation result information is, for example, a database, and can include a plurality of reservation accepting records.

Further, when matching between the user 110, or the like, and the vehicle for ride-sharing is achieved, the vehicle ride-sharing matching apparatus 106 generates a matching achievement record and stores matching achievement information including the generated matching achievement record. The matching achievement record is a record concerning content of the matching for each vehicle for ride-sharing for which matching is achieved, and includes records relating to a location where the user rides in a vehicle, a date at which the user rides in a vehicle, a time slot in which the user rides in a vehicle, and a route on which the user rides in a vehicle in the matching. Here, the record relating to the location where the user rides in a vehicle is, for example, a record indicating a location where the user rides in the vehicle for ride-sharing in the matching, the record relating to the date at which the user rides in a vehicle is a date at which the user rides in the vehicle for ride-sharing in the matching, and the record relating to the time slot in which the user rides in a vehicle is a time slot in which the user rides in the vehicle for ride-sharing in the matching. The information relating to the route on which the user rides in a vehicle is information as to a route on which the vehicle for ride-sharing travels, and can include, for example, information of locations (places) where respective users who ride in a vehicle get off the vehicle. Further, the matching achievement record can include a record of the number of users who ride in a vehicle which is the number of users who ride in the vehicle for ride-sharing at the locations where the users ride in the vehicle.

Here, in a case where users are respectively allowed to ride in one vehicle for ride-sharing at a plurality of different places, the vehicle ride-sharing matching apparatus 106 generates matching achievement records relating to the one vehicle for ride-sharing, so as to respectively correspond to the above-described plurality of places, and stores the matching achievement records as matching achievement information.

In the example in FIG. 1, for example, the users 120 and 122 are matched with the vehicle for ride-sharing 160, and the users 124, 126 and 128 are matched with the vehicle for ride-sharing 162 by the vehicle ride-sharing matching apparatus 106. By this means, the vehicle ride-sharing matching apparatus 106 stores two matching achievement records as the matching achievement information. One is a matching achievement record relating to the vehicle for ride-sharing 160, and includes records of park 154 as the location where the user rides in a vehicle, for example, March 4 as the date at which the user rides in a vehicle, for example, from 17:30 to 18:00 as the time slot in which the user rides in a vehicle, station 156 as the route on which the user rides in a vehicle, 2 (that is, two persons of the users 120 and 122) as the number of users who ride in a vehicle, or the like. The other is a matching achievement record relating to the vehicle for ride-sharing 162, and includes records of park 154 as the location where the user rides in a vehicle, for example, March 4 as the date at which the user rides in a vehicle, for example, from 18:00 to 18:30 as the time slot in which the user rides in a vehicle, hotel 158 as the route on which the user rides in a vehicle, 3 (that is, three persons of the users 124, 126 and 128) as the number of users who ride in a vehicle, or the like.

Note that, in the example in FIG. 1, it is assumed that the vehicle ride-sharing matching apparatus 106 has already stored the matching achievement information including the above-described matching information over the past one month. Here, the reservation result information is, for example, a database, and can include a plurality of matching achievement records.

In the above-described configuration, the vehicle ride-sharing support system 100 first acquires reservation result information including the past reservation accepting records from the vehicle ride-sharing matching apparatus 106 and stores the reservation result information. That is, the vehicle ride-sharing support system 100 acquires and stores a reservation accepting record for each matching reservation request, the reservation accepting record being indicative of the following indicated in the matching reservation request: a reserved location for riding in a vehicle; a reserved date for riding in a vehicle; a reserved time slot for riding in a vehicle; and a reserved location for getting off a vehicle, the matching reservation request being transmitted from, for example, a mobile terminal which is the user terminal apparatus of the user for requesting reservation of matching with the vehicle for ride-sharing.

Further, the vehicle ride-sharing support system 100 acquires matching achievement information including the past matching achievement records from the vehicle ride-sharing matching apparatus 106 and stores the matching achievement information. That is, the vehicle ride-sharing support system 100 acquires and stores a matching achievement record indicating a location where the user rides in a vehicle, a date at which the user rides in a vehicle, a time slot in which the user rides in a vehicle and a route on which the user rides in a vehicle for each vehicle for ride-sharing for which matching is achieved.

It is assumed here that acquisition of the reservation result information and the matching achievement information from the vehicle ride-sharing matching apparatus 106 is performed, for example, at predetermined time intervals (for example, 24 o'clock every day).

Further, the vehicle ride-sharing support system 100 acquires desired condition information including a desired location for riding in a vehicle, a desired date for riding in a vehicle, a desired time slot for riding in a vehicle, and a desired location for getting off a vehicle, which are desired by the user 110, or the like, regarding the vehicle for ride-sharing from, for example, the mobile terminal 130, or the like, which is the user terminal apparatus utilized by the user 110, or the like. For example, in the example in FIG. 1, the users 110 and 112 transmit desired condition information in which, for example, a location of company 150 is set as the desired location for riding in a vehicle, using the mobile terminals 130 and 132 from, for example, a location near the company 150 which is office at which the users work. Further, the user 114 transmits desired condition information in which, for example, a location of a department store 152 is set as the desired location for riding in a vehicle using the mobile terminal 134 from a location near the department store 152 at which the user has finished shopping. Further, the users 116 and 118 transmit desired condition information in which a location of a park 154 is set as the desired location for riding in a vehicle using the mobile terminals 136 and 138 from a location near the park 154.

The vehicle ride-sharing support system 100 acquires the above-described respective pieces of desired condition information of the users 110, 112, 114, 116 and 118 from the mobile terminals 130, 132, 134, 136 and 138 which are the user terminal apparatuses of the users 110, 112, 114, 116 and 118 who desire ride-sharing of a vehicle.

Then, the vehicle ride-sharing support system 100 sets an area within a predetermined distance range including the desired location for riding a vehicle indicated by the desired condition information acquired from the user 110, or the like, on the basis of the reservation result information and/or the matching achievement information acquired from the vehicle ride-sharing matching apparatus 106 (thus, on the basis of the reservation accepting record and/or the matching achievement record). The vehicle ride-sharing support system 100 then calculates a value of an index (index value) indicating a difficulty level of achievement of matching for each predetermined time slot for each of predetermined locations within the set area.

In the above, in a case where the index value of the index based on the reservation accepting record is calculated, for example, the reserved location for riding a vehicle included in the reservation accepting record of the reservation result information can be set as the above-described predetermined location. Further, a time slot determined in advance, for example, each of time slots obtained by dividing 24 hours of one day for each of 30 minutes can be set as the above-described predetermined time slot.

Further, for example, the number of persons who make reservations which is the number of users who make reservations while the above-described predetermined location is set as the reserved location for riding in a vehicle, and the above-described predetermined time slot is set as the reserved time slot for riding in a vehicle, in the past predetermined period (for example, the latest one month), can be set as the index or the index value based on the reservation accepting record.

Alternatively, for example, the average number of persons per day (the average number of persons who make reservations) of the number of persons who make reservations which is the number of users who make reservations while the above-described predetermined location is set as the reserved location for riding in a vehicle, and the above-described predetermined time slot is set as the reserved time slot for riding in a vehicle, in the past predetermined period, can be set as the index or the index value based on the reservation accepting record.

Alternatively, for example, a proportion of persons who make reservations which is a proportion of persons who make reservations while the above-described predetermined time slot is set as the reserved time slot for riding in a vehicle, to the persons who make reservations while the above-described predetermined location is set as the reserved location for riding in a vehicle in the past predetermined period or at the past predetermined date, can be set as the index or the index value based on the reservation accepting record.

Alternatively, the vehicle ride-sharing support system 100 can set, for example, the location where the user rides in a vehicle indicated by the matching achievement record of the matching achievement information as the above-described predetermined location in a case where the index value of the index based on the matching achievement record is calculated. Further, a time slot determined in advance, for example, each of time slots obtained by dividing 24 hours of one day for each of 30 minutes can be set as the above-described predetermined time slot.

Further, for example, a matching achievement probability (matching probability) which indicates a proportion of the number of days in which matching with the vehicle for ride-sharing is achieved in the above-described predetermined time slot at the above-described predetermined location within the above-described predetermined period to the number of days in the past predetermined period can be set as the index or the index value based on the matching achievement record.

Then, the vehicle ride-sharing support system 100 outputs the above-described calculated index value for each of the above-described predetermined time slots for each of the above-described predetermined locations to, for example, the mobile terminal 130, or the like, which is the user terminal apparatus of the user 110, or the like, from which the above-described desired condition information is acquired (that is, a transmission source).

For example, in the example in FIG. 1, the vehicle ride-sharing support system 100 acquires respective pieces of desired condition information from the mobile terminals 130, 132, 134, 136 and 138 of the users 110, 112, 114, 116 and 118, and respectively calculates the above-described index values in accordance with the acquired respective pieces of the desired condition information. Then, the vehicle ride-sharing support system 100 outputs the calculated respective index values respectively to the mobile terminals 130, 132, 134, 136 and 138 of the users 110, 112, 114, 116 and 118, from which the corresponding desired condition information is acquired.

Each of the mobile terminals 130, 132, 134, 136 and 138 which receive the above-described respective index values from the vehicle ride-sharing support system 100 can, for example, display a map (index value map) in which display in accordance with the above-described calculated index values or magnitudes of the index values is indicated at positions on the map respectively corresponding to the above-described predetermined locations on the basis of the received index values. This index value map can be, for example, generated and displayed using the index values in a predetermined time slot which is the same as the desired time slot for riding in a vehicle indicated by the desired condition information. Further, this index value map can be created again and displayed in response to one of the above-described predetermined time slots being input from the users 110, 112, 114, 116 and 118 thereafter, using the index values in the input one time slot.

Alternatively, each of the mobile terminals 130, 132, 134, 136 and 138 which receive the above-described index values from the vehicle ride-sharing support system 100 can, for example, display a diagram (index value transition graph) indicating transition of the index value at one predetermined location along the above-described predetermined time slots on the basis of the above-described received index values. This index value transition graph can be, for example, created and displayed regarding the index values at one predetermined location in response to the one predetermined location being input from the users 110, 112, 114, 116 and 118.

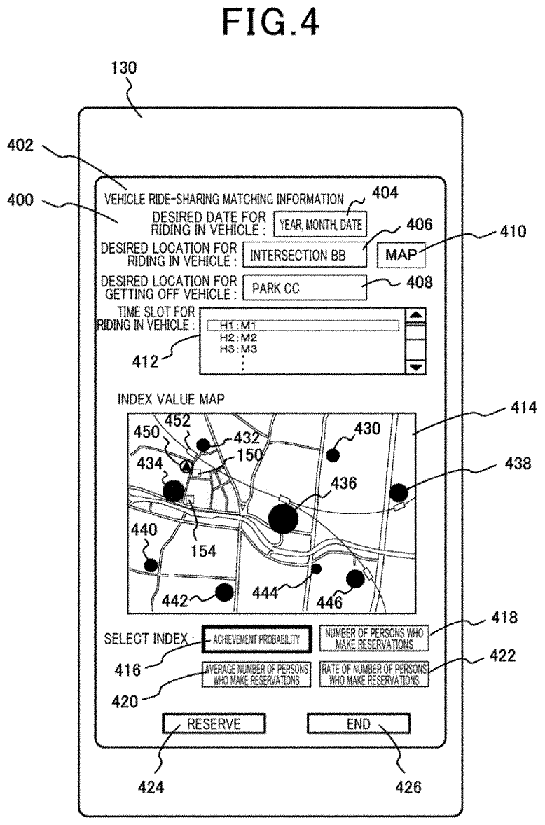

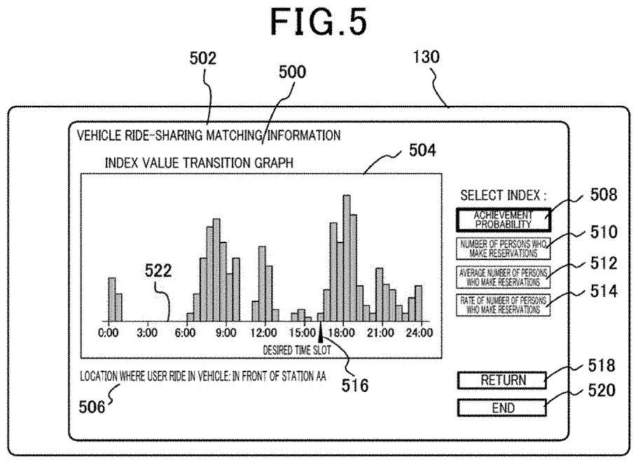

FIG. 4 and FIG. 5 are diagrams illustrating an example of a display screen of the index value map and a display screen of the index value transition graph at, for example, the mobile terminal 130. Display screens similar to the display screens illustrated in FIG. 4 and FIG. 5 can be also displayed at the mobile terminals 132, 134, 136 and 138 of other users 112, 114, 116 and 118. Note that the display screens illustrated in FIG. 4 and FIG. 5 can be displayed by the mobile terminal 130 executing, for example, a dedicated application program.

On the display screen 400 of the mobile terminal 130 illustrated in FIG. 4, below a title 402 of “vehicle ride-sharing matching information”, a box for inputting a desired date for riding in a vehicle 404, a box for inputting a desired location for riding in a vehicle 406, a box for inputting a desired location for getting off a vehicle 408, a map display button 410, and a list for inputting a time slot for riding in a vehicle 412, are displayed.

The user 110 can input the desired date for riding in a vehicle, the desired location for riding in a vehicle and the desired location for getting off a vehicle respectively in the box for inputting a desired date for riding in a vehicle 404, the box for inputting a desired location for riding in a vehicle 406, and the box for inputting a desired location for getting off a vehicle 408. Upon input to the box for inputting a desired location for riding in a vehicle 406 and the box for inputting a desired location for getting off a vehicle 408, the user 110 can, for example, depress respective map display buttons 410 to cause a map (not illustrated) to be displayed on the display screen 400 and can input the desired location for riding in a vehicle and the desired location for getting off a vehicle by touching desired positions on the map.

The list for inputting a time slot for riding in a vehicle 412 is a drop-down list in which a list of predetermined time slots determined in advance is displayed. The user 110 can select and input one predetermined time slot as the desired time slot for riding in a vehicle by touching the one predetermined time slot displayed in the list for inputting a time slot for riding in a vehicle 412. The selected and input time slot is, for example, displayed so that a corresponding row is inverted, so as to indicate that the time slot indicated in the row is selected and input. In FIG. 4, inverted display is displayed as a rectangular frame in an abbreviated manner.

If the user 110 selects and inputs the desired time slot for riding in a vehicle in the list for inputting a time slot for riding in a vehicle 412 after performing input to the box for inputting a desired date for riding in a vehicle 404, the box for inputting a desired location for riding in a vehicle 406, and the box for inputting a desired location for getting off a vehicle 408, the desired condition information including these input desired location for riding in a vehicle, desired time slot for riding in a vehicle, and desired location for getting off a vehicle is transmitted from the mobile terminal 130 to the vehicle ride-sharing support system 100. The vehicle ride-sharing support system 100 calculates the index value and transmits the index value to the mobile terminal 130 in response to the desired condition information being received from the mobile terminal 130.

The mobile terminal 130 displays the index value map 414 on the display screen 400 in response to the index value being received from the vehicle ride-sharing support system 100. The index value to be used in the index value map 414 is, for example, the matching achievement probability calculated on the basis of the matching achievement record by default. The user 110 can set (or change) each of index values to be used for display of the index value map 414 as one of the matching achievement probability, the number of persons who make reservations, the average number of persons who make reservations and a proportion of the number of persons who make reservations by the user 110 depressing one of the index selection buttons 416, 418, 420 and 422 displayed on the display screen 400. Here, as described above, the matching achievement probability is an index value based on the matching achievement record, and the number of persons who make reservations, the average number of persons who make reservations, and the proportion of the number of persons who make reservations are index values based on the reservation accepting record.

The index value which is currently being used can be indicated by, for example, display of the corresponding index selection button 416, 418, 420 or 422 being highlighted (for example, inverted). In the example in FIG. 4, the index value which is currently being used being the matching achievement probability which is set by default is indicated by display of the index selection button 416 being highlighted (displayed with a thick frame line in the drawing).

The index value map 414 is a map in which, for example, display in accordance with magnitudes of the above-described calculated index values is respectively indicated at positions on the map, respectively corresponding to the predetermined locations. In the example in FIG. 4, the above-described display is black circles 430, 432, 434, 436, 438, 440, 442, 444 and 446 (hereinafter, also referred to as a black circle 430, or the like) having sizes (for example, diameters or areas) in accordance with the magnitudes of the index values. Note that, in place of the display in accordance with the magnitudes of the index values, like the black circle 430, or the like, numerical values themselves of the index values or numerical values or reference numerals indicating the magnitudes of the index values (such as, for example, standardized index values standardized by a maximum value of the index values, and reference numerals representing ranks indicating ranges of the magnitudes of the index values) may be displayed at the corresponding predetermined positions on the map.

On the index value map 414, further, the desired location for riding in a vehicle input by the user 110 in the box for inputting a desired location for riding in a vehicle 406 is indicated with a mark of the desired location for riding in a vehicle 450. Further, on the index value map 414, the company 150 and the park 154 illustrated in FIG. 1 are also indicated. A location of the company 150 is, for example, a current location of the user 110.

Near the mark of the desired location for riding in a vehicle 450, a station 452 and the park 154 are located. On the index value map 414, in the vicinity of the station 452 and the park 154, black circles 432 and 434 representing the magnitudes of the above-described index values which are respectively located at the station 452 and the park 154 as the predetermined locations, are indicated.

The user 110 can recognize that there is no black circle at the desired location for riding in a vehicle (location of the mark of the desired location for riding in a vehicle 450 on the index value map 414) input to the box for inputting a desired location for riding in a vehicle 406, and thus, matching has not been achieved at this location, by referring to the index value map 414. Further, the user 110 can recognize from the index value map 414 that a place where matching is likely to be achieved is the station 452 or the park 154, and matching is higher likely to be achieved at the park 154 than at the station 452.

By this means, in a case where priority is given to a distance from the current location to the location at which the user rides in a vehicle, the user 110 can change the desired location for riding in a vehicle at the station 452, and, in a case where priority is given to a matching possibility, the user 110 can change the desired location for riding in a vehicle to the park 154. Thereafter, when the user 110 inputs, for example, the station 452 or the park 154 in the box for inputting a desired location for riding in a vehicle 406, and depresses a reservation button 424 displayed on the display screen 400, a matching reservation request including content input on the display screen 400 is transmitted to the vehicle ride-sharing matching apparatus 106.

That is, the matching reservation request in which the date input to the box for inputting a desired date for riding in a vehicle 404 is set as the reserved date for riding in a vehicle, the desired location for riding in a vehicle and the desired location for getting off a vehicle respectively input to the box for inputting a desired location for riding in a vehicle 406 and the box for inputting a desired location for getting off a vehicle 408 are respectively set as the reserved location for riding in a vehicle and the reserved location for getting off a vehicle, and the desired time slot for riding in a vehicle selected in the list for inputting a time slot for riding in a vehicle 412 is set as the reserved time slot for riding in a vehicle, is transmitted to the vehicle ride-sharing matching apparatus 106. Alternatively, the user 110 can finish the display screen 400 by depressing an end button 426.

The index value map 414 based on the index values in other time slots may be displayed by the user 110 selecting and inputting other time slots in the list for inputting a time slot for riding in a vehicle 412. That is, the index value map 414 can be displayed in accordance with one of the predetermined time slots being input from the user.

Further, alternatively, by the user 110, for example, touching one of the predetermined locations at which the black circles 430, or the like, are displayed on the index value map 414, the user 110 can display an index value transition graph concerning the touched predetermined locations, for example, on the display screen 500 illustrated in FIG. 5.

In FIG. 5, on the display screen 500 of the mobile terminal 130, a title 502 having the same content as that of the display screen 400, an index value transition graph 504, a text of a desired location for riding in a vehicle 506, index selection buttons 508, 510, 512 and 514, a return button 518 and an end button 520 are displayed.

The index value transition graph 504 is a diagram indicating transition of the index value along the predetermined time slots at the predetermined location touched by the user 110 on the index value map 414 illustrated in FIG. 4. That is, the index value transition graph 504 is a diagram indicating transition of the index value along predetermined time slots at the predetermined location displayed in accordance with one of the predetermined locations being input by the user 110. Specifically, the index value transition graph 504 illustrated in FIG. 5 is an index value transition graph displayed by, for example, the user 110 touching the station 452 (or the black circle 432 in the vicinity of the station 452) on the index value map 414.

Name of “IN FRONT OF STATION AA” of the predetermined location near the station 452 is indicated as the text of the desired location for riding in a vehicle 506. By this means, the user 110 can know that transition of the index value indicated by the index value transition graph 504 is related to IN FRONT OF STATION AA (that is, the station 452).

The index selection buttons 508, 510, 512 and 514 are similar to the index selection buttons 416, 418, 420 and 422 illustrated in FIG. 4, and are used to set (or change) the index to be used for display of the index value transition graph 504 at one of the matching achievement probability, the number of persons who make reservations, the average number of persons who make reservations and the proportion of the number of persons who make reservations. Further, display of the index selection button corresponding to the index value which is currently being used is highlighted. In the example in FIG. 5, as a result of display of the index selection button 508 being highlighted (in the drawing, display with a thick frame in an abbreviated manner), it is indicated that the index value which is currently being used for display of the index value transition graph 504 is the matching achievement probability.

In the index value transition graph 504, transition of the index value along the predetermined time slots obtained by dividing 24 hours of one day for each of 30 minutes “IN FRONT OF STATION AA” is indicated with a bar graph. Further, in the index value transition graph 504, a marker 516 indicating the desired time slot for riding in a vehicle selected in the list for inputting a time slot for riding in a vehicle 412 in FIG. 4 is also indicated.

The user 110 recognizes that a likelihood of achievement of matching is likely to significantly increase by changing the desired time slot for riding in a vehicle by approximately one hour from the time slot which is currently being selected, indicated with the marker 516, by referring to the index value transition graph 504. By this means, the user 110 can, for example, decide to change the desired time slot for riding in a vehicle by moving to the station 452 after waiting for approximately one hour instead of immediately heading for an intersection 544 which is farther than the station 452 which is STATION AA.

That is, while, in a case of the index value map 414 in FIG. 4, it is possible to guide the user 110 to a predetermined location where matching is more likely to be achieved, in the index value transition graph 504 in FIG. 5, it is possible to guide the user 110 to a time slot in which matching is more likely to be achieved.

The user 110 can depress the return button 518 displayed on the display screen 500 to return to the display screen 400 illustrated in FIG. 4, and can correct the desired time slot for riding in a vehicle in the list for inputting a time slot for riding in a vehicle 412 as described above. Thereafter, the user 110 can transmit the matching reservation request to the vehicle ride-sharing matching apparatus 106 on the conditions input on the display screen 400 by depressing the reservation button 424.

Alternatively, the user 110 can input one of other predetermined time slots by touching a portion (for example, a portion corresponding to 15:00 to 15:30) indicating a time slot on a left side of the marker 516 in the drawing on a time axis 522 (line which extends in a left-right direction in the drawing and which connects “0:00” and “24:00” in the drawing) within the index value transition graph 504. By this means, the mobile terminal 130 can, for example, return to the display screen illustrated in FIG. 4 and can display the index value map 414 in the above-described input another predetermined time slot.

For example, in a case where the user 110 desires to ride in a vehicle for ride-sharing as soon as possible, the user 110 can touch a portion indicating a time slot on a left side of the marker 516 in the drawing among the time axis 522 within the index value transition graph 504 to cause the index value map 414 in the predetermined time slot corresponding to the touched portion to be displayed at the mobile terminal 130.

By this means, the user 110 can search for a predetermined location where matching is more likely to be achieved in an earlier time slot by referring to the displayed index value map 414.

Further, alternatively, the user 110 can finish the display screen 500 by depressing the end button 520 on the display screen 500.

By the above-described operation, the vehicle ride-sharing support system 100 presents the index value indicating a difficulty level of achievement of matching to the vehicle for ride-sharing, to the user 110, or the like, who is a transmission source of the desired condition information, in accordance with the desired condition information of the user 110, or the like. Then, this index value includes index values regarding predetermined locations around the desired location for riding in a vehicle and predetermined time slots before and after the desired time slot for riding in a vehicle, in addition to the index value regarding the desired location for riding in a vehicle and the desired time slot for riding in a vehicle indicated by the desired condition information.

Therefore, the user 110, or the like, can, for example, change the desired location for riding in a vehicle and the desired time slot for riding in a vehicle to a predetermined location and a predetermined time slot which have higher index values and in which matching to the vehicle for ride-sharing is more likely to be achieved. As a result, in the vehicle ride-sharing support system 100, it is possible to increase a possibility of achievement of matching between the user 110, or the like, and the vehicle for ride-sharing by encouraging the user 110, or the like, who desires ride-sharing of a vehicle to adjust the desired location for riding in a vehicle and the desired time slot for riding in a vehicle.

Further, because the user 110, or the like, who desires ride-sharing of a vehicle is guided to a predetermined location with a higher possibility of achievement of matching, it is possible to avoid a situation where the vehicle for ride-sharing repeatedly stops within a narrow distance range a number of times to allow the user to ride in the vehicle. Further, for a similar reason, it is possible to avoid a situation where all the users cannot be matched to the vehicle for ride-sharing because the users who can originally utilize the same vehicle for ride-sharing dispersedly exist. As a result, because, in the vehicle ride-sharing support system 100, because more users are guided to ride in the same vehicle for ride-sharing, it is possible to reduce the number of vehicles for ride-sharing, so that it is possible to contribute to relief of traffic congestion and reduction in a discharge amount of CO₂.

The vehicle ride-sharing support system 100, the mobile terminal 130 and operation of the vehicle ride-sharing support system 100 will be sequentially described below.

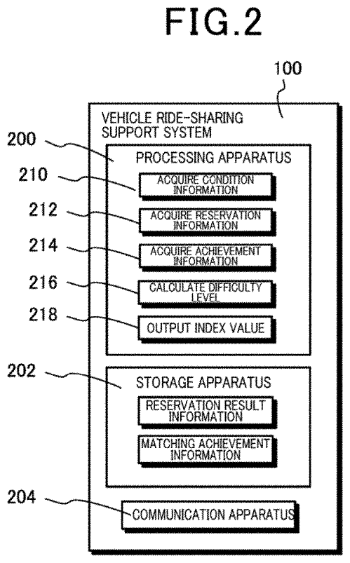

First, a configuration of the vehicle ride-sharing support system 100 will be described. FIG. 2 is a diagram illustrating an example of the configuration of the vehicle ride-sharing support system 100. The vehicle ride-sharing support system 100 includes a processing apparatus 200, a storage apparatus 202 and a communication apparatus 204. The storage apparatus 202 is configured with, for example, a volatile semiconductor memory and a non-volatile semiconductor memory, and/or a hard disk apparatus, and stores data and/or a program required for operation of the processing apparatus 200. Further, in the storage apparatus 202, for example, reservation result information and matching achievement information acquired from the vehicle ride-sharing matching apparatus 106 are stored.

The communication apparatus 204 is a transmitter/receiver which performs wired communication and/or wireless communication. The communication apparatus 204 connects the processing apparatus 200 to the mobile terminal 130, or the like, of the user 110, or the like, indirectly via the network 104 or directly without involving the network 104 so as to be able to perform communication. The communication apparatus 204 further connects the processing apparatus 200, for example, to the vehicle ride-sharing matching apparatus 106 via the network 104 so as to be able to perform communication.

The processing apparatus 200 is, for example, a computer including a processor such as a central processing unit (CPU). The processing apparatus 200 may have a configuration having a read only memory (ROM) in which a program is written, a random access memory (RAM) for temporarily storing data, or the like. Further, the processing apparatus 200 includes a condition information acquiring unit 210, a reservation information acquiring unit 212, an achievement information acquiring unit 214, a difficulty level calculating unit 216 and an index value output unit 218 as functional elements or functional units.

These functional elements of the processing apparatus 200 are implemented by, for example, the processing apparatus 200 which is a computer executing the program. Note that the above-described computer program can be stored in an arbitrary computer-readable storage medium. In place of this, all or part of the above-described functional elements of the processing apparatus 200 can be configured with hardware respectively including one or more electronic circuit components.

The condition information acquiring unit 210 acquires the desired condition information including the desired location for riding in a vehicle, the desired date for riding in a vehicle, the desired time slot for riding in a vehicle, and the desired location for getting off a vehicle, which are desired by the user 110, or the like, regarding the vehicle for ride-sharing from the mobile terminal 130, or the like, which is the user terminal apparatus utilized by the user 110, or the like.

The reservation information acquiring unit 212 acquires and stores the reservation accepting record for each matching reservation request, the reservation accepting record being indicative of the following indicated in the matching reservation request: the reserved location for riding in a vehicle; the reserved date for riding in a vehicle; the reserved time slot for riding in a vehicle; and the reserved location for getting off a vehicle, the matching reservation request being transmitted from the mobile terminal 130, or the like, of the user 110, or the like for requesting reservation of matching of a vehicle for ride-sharing. In the example in FIG. 1, the vehicle ride-sharing matching apparatus 106 stores the above-described reservation accepting record regarding each of the above-described matching reservation requests received from the mobile terminals 130, or the like, as reservation result information. The reservation information acquiring unit 212, then, for example, acquires the above-described reservation accepting record by acquiring the above-described reservation result information from the vehicle ride-sharing matching apparatus 106 and stores the reservation accepting record in the storage apparatus 202. However, this is merely an example, and the reservation information acquiring unit 212 may receive the matching reservation requests from the mobile terminal 130, or the like, may generate and acquire the above-described reservation accepting record for each of the received matching reservation requests and may store the reservation accepting record in the storage apparatus 202.

The achievement information acquiring unit 214 acquires and stores a matching achievement record indicating a location at which the user rides in a vehicle, a date at which the user rides in a vehicle, a time slot in which the user rides in a vehicle and a route through which the user rides in a vehicle for each vehicle for ride-sharing for which matching with the user 110, or the like, is achieved. In the example in FIG. 1, when matching between the user 110, or the like, and the vehicle for ride-sharing is achieved, the vehicle ride-sharing matching apparatus 106 generates the above-described matching achievement record and stores the matching achievement record as the matching achievement information. The achievement information acquiring unit 214 then acquires the above-described matching achievement record, for example, by acquiring the above-described matching achievement information from the vehicle ride-sharing matching apparatus 106, and stores the matching achievement record in the storage apparatus 202. However, this is merely an example, and the achievement information acquiring unit 214 may receive information regarding matching with the vehicle for ride-sharing matched for the user 110, or the like, from the mobile terminal 130, or the like, of the user 110, or the like, may generate and acquire the above-described matching achievement record on the basis of the received information, and may store the matching achievement record in the storage apparatus 202.

The difficulty level calculating unit 216 calculates an index value of an index representing a difficulty level of achievement of matching between the vehicle for ride-sharing and the user for each of predetermined locations in an area within a predetermined distance range including the above-described desired location for riding in a vehicle and for each predetermined time slot including the above-described time slot for riding in a vehicle. Specifically, the difficulty level calculating unit 216 sets an area within a predetermined distance range including the desired location for riding in a vehicle indicated in the acquired desired condition information in response to the condition information acquiring unit 210 acquiring the desired condition information from the mobile terminal 130, or the like, of the user 110, or the like. Then, the difficulty level calculating unit 216 calculates the above-described index value for each of the above-described predetermined time slots for each of the above-described predetermined locations in the set area. As described above, time slots obtained by dividing 24 hours of one day for each of 30 minutes can be set as the predetermined time slots.

In one aspect, the difficulty level calculating unit 216 calculates the above-described index value on the basis of the matching achievement record stored by the achievement information acquiring unit 214. That is, the difficulty level calculating unit 216 calculates the reservation accepting record based on the above-described matching achievement record. In this case, the location where the user rides in a vehicle indicated by the matching achievement record can be set as the above-described predetermined location.

Further, in the above-described one aspect, a matching achievement probability (matching probability) indicating a proportion of the number of days in which matching to the vehicle for ride-sharing is achieved in the above-described predetermined time slot at the above-described predetermined location within a predetermined period, to the number of days in the past predetermined period can be used as the above-described index value. Here, the “number of days in which matching is achieved” in the predetermined time slot can be calculated by, for example, extracting the matching achievement records including the date at which the user rides in a vehicle within the above-described past predetermined period from the matching achievement records of the matching achievement information stored in the storage apparatus 202 and counting the number of matching achievement records in which the location where the user rides in a vehicle includes the above-described predetermined location, and the time slot in which the user rides in a vehicle includes the above-described predetermined time slot among the extracted matching achievement records.

In another aspect, the difficulty level calculating unit 216 calculates the above-described index value on the basis of the past reservation accepting records stored by the reservation information acquiring unit 212. That is, the difficulty level calculating unit 216 calculates the index value based on the above-described reservation accepting records. In this case, the reserved location for riding in a vehicle indicated by the above-described reservation accepting record can be used as the above-described predetermined location.

Further, in the above-described another aspect, the number of persons who make reservations which is the number of users who make reservations while the above-described predetermined location is set as the reserved location for riding in a vehicle and the above-described predetermined time slot is set as the reserved time slot for riding in a vehicle in a past predetermined period (for example, one month) can be used as the above-described index value. Here, the “number of persons who make reservations” while the reserved time slot for riding in a vehicle is set as the predetermined time slot can be calculated as, for example, the number of reservation accepting records which include the reserved date for riding in a vehicle within the above-described predetermined period, include the above-described predetermined location as the reserved location for riding in a vehicle, and include the above-described predetermined time slot as the reserved time slot for riding in a vehicle, among the reservation accepting records of the reservation result information stored in the storage apparatus 202.

Further, in the above-described another aspect, the average number of persons who make reservations per day of the above-described number of persons who make reservations which is the number of users who make reservations while the above-described predetermined location is set as the reserved location for riding in a vehicle, and the above-described predetermined time slot is set as the reserved time slot for riding in a vehicle in the past predetermined period, can be used as the above-described index value. Here, the “average number of persons who make reservations per day” of the number of persons who make reservations while the predetermined time slot is set as the reserved time slot for riding in a vehicle can be calculated as, for example, a value obtained by dividing the above-described number of persons who make reservations by the number of days in the above-described past predetermined period.

Further, in the above-described another aspect, a proportion of persons who make reservations which is a proportion of the number of persons who make reservations while the above-described predetermined time slot is set as the reserved time slot for riding in a vehicle to the number of persons who make reservations in all time slots in which the above-described predetermined location is set as the reserved location for riding in a vehicle in a past predetermined period or at a past predetermined date can be used as the above-described index value. Here, the “proportion of persons who make reservations” in which the predetermined time slot is set as the reserved time slot for riding in a vehicle can be calculated as, for example, a ratio of n reservation accepting records further including the above-described predetermined time slot as the reserved time slot for riding in a vehicle among N reservation accepting records, to N reservation accepting records including the reserved date for riding in a vehicle within the above-described predetermined period or at the above-described predetermined date and including the above-described predetermined location as the reserved location for riding in a vehicle among the reservation accepting records of the reservation result information stored in the storage apparatus 202.

Here, the above-described number of persons who make reservations, average number of persons who make reservations and proportion of persons who make reservations may be calculated for the day which is the same as the day of the desired date for riding in a vehicle in the past predetermined period, as well as being calculated for the past predetermined period as described above.

Note that, in the present embodiment, the difficulty level calculating unit 216 does not use the desired location for getting off a vehicle included in the desired condition information for calculating the index value. This is because, typically, matching between the vehicle for ride-sharing and the user is more likely to be achieved at a location or in a time slot at or in which a number of reservation accepting records and matching achievement records are generated regardless of the desired location for getting off a vehicle, and even if the index value is calculated without taking into account information of the desired location for getting off a vehicle, it is possible to appropriately guide the user to a location and a time slot in which matching is more likely to be achieved.

The index value output unit 218 outputs an index value for each of the above-described predetermined time slots for each of the above-described predetermined locations calculated by the difficulty level calculating unit 216, to the mobile terminal 130, or the like, which is the user terminal apparatus of the user 110, or the like, from which the desired condition information relating to calculation of the index value is acquired (that is, a transmission source).

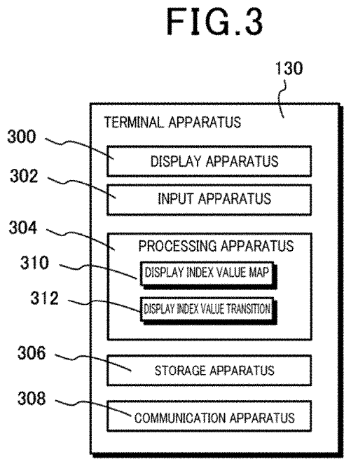

A configuration of the mobile terminal 130, or the like, of the user 110, or the like, will be described next. The mobile terminal 130, or the like, can be configured to have the same configuration. Therefore, in the following description, the configuration of the mobile terminal 130 will be described as an example. FIG. 3 is a diagram illustrating an example of the configuration of the mobile terminal 130.

The mobile terminal 130 includes a display apparatus 300 (display), an input apparatus 302, a processing apparatus 304, a storage apparatus 306 and a communication apparatus 308. The display apparatus 300 is, for example, a liquid crystal display apparatus. The input apparatus 302 is, for example, a touch panel disposed on a display screen of the display apparatus 300 which is a liquid crystal display apparatus. The input apparatus 302 accepts data and an instruction input from the user 110 and outputs the data and the instruction to the processing apparatus 304.

The storage apparatus 306 is configured with, for example, a volatile semiconductor memory and a non-volatile semiconductor memory, and/or a hard disk apparatus, and stores data and/or a program required for operation of the processing apparatus 304.

The communication apparatus 308 is a transmitter/receiver which performs wired communication and/or wireless communication. The communication apparatus 308 connects the processing apparatus 304 to the vehicle ride-sharing support system 100 and the vehicle ride-sharing matching apparatus 106 indirectly via the network 104 or directly without involving the network 104, so as to be able to perform communication.

The processing apparatus 304 is, for example, a computer including a processor such as a CPU. The processing apparatus 304 may have a configuration including a ROM in which a program is written, a RAM for temporarily storing data, or the like. Further, the processing apparatus 304 includes an index value map display unit 310 and an index value transition display unit 312 as functional elements or functional units.

These functional elements of the processing apparatus 304 are implemented by, for example, the processing apparatus 304 which is a computer executing an application program. Note that the above-described application program can be stored in advance in an arbitrary computer-readable storage medium. In place of this, all or part of the above-described functional elements of the processing apparatus 304 can be configured with hardware respectively including one or more electronic circuit components. Note that the above-described application program can be downloaded from an application server, or the like, which is connected to the network 104, or the like, and which provides the application program, and can be stored in the above-described storage medium in accordance with related art, as well as being stored in advance in the above-described storage medium.

The index value map display unit 310 receives the above-described calculated index value from the vehicle ride-sharing support system 100 and displays an index value map which is a map in which display in accordance with the above-described index value or a magnitude of the index value is indicated at a position corresponding to the above-described predetermined location, at the display apparatus 300 in response to one of the above-described predetermined time slot being input from the user 110 via the input apparatus 302. One of the above-described predetermined time slots can be, for example, input by the user 110 selecting one of the time slots in the list for inputting a time slot for riding in a vehicle 412 on the display screen 400 illustrated in FIG. 4 displayed at the display apparatus 300 by the processing apparatus 304, or by the user 110 touching part of the time axis 522 on the display screen 500 illustrated in FIG. 5.

The index value transition display unit 312 receives the above-described calculated index value from the vehicle ride-sharing support system 100, and displays an index value transition graph which is a diagram illustrating transition of the above-described calculated index value at the predetermined location along the above-described predetermined time slots at the display apparatus 300, in response to one of the above-described predetermined locations being input from the user 110 via the input apparatus 302. One of the above-described predetermined locations can be, for example, input by the user 110 touching one of the predetermined locations displayed at the index value map 414 on the display screen 400 illustrated in FIG. 4 displayed at the display apparatus 300 by the processing apparatus 304.

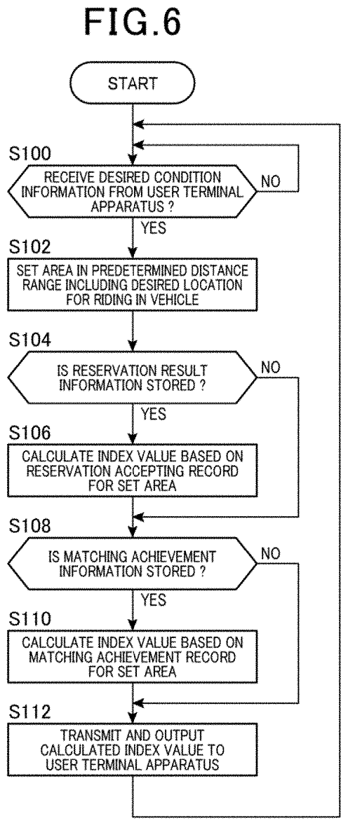

Operation in the vehicle ride-sharing support system 100 will be described next. FIG. 6 is a flowchart illustrating procedure of processing in the vehicle ride-sharing support system 100. The present processing is started when the vehicle ride-sharing support system 100 is powered on, and ends when the vehicle ride-sharing support system 100 is powered off. Note that, in parallel to the present processing, the vehicle ride-sharing support system 100 acquires the matching achievement information including the matching achievement records and the reservation result information including the reservation accepting records from the vehicle ride-sharing matching apparatus 106 at predetermined time intervals (for example, for each day) and stores the matching achievement information and the reservation result information in the storage apparatus 202. Here, acquisition and storage of the matching achievement information are performed by the achievement information acquiring unit 214 of the processing apparatus 200, and acquisition and storage of the reservation result information are performed by the reservation information acquiring unit 212.

In FIG. 6, when the processing is started, the vehicle ride-sharing support system 100 first determines whether or not the desired condition information is received from one of the mobile terminals 130, or the like, which are user terminal apparatuses of the users 110, or the like, by the condition information acquiring unit 210 of the processing apparatus 200 (S100). Then, when the desired condition information is not received (S100: No), the condition information acquiring unit 210 returns to step S100 and waits until the desired condition information is received from one of the mobile terminals 130, or the like.

Meanwhile, when the desired condition information is received from one of the mobile terminals 130, or the like (S100: Yes), the condition information acquiring unit 210 outputs the received desired condition information to the difficulty level calculating unit 216. The difficulty level calculating unit 216 sets an area in a predetermined distance range (for example, a rectangular area having a predetermined distance as one side) including the desired location for riding in a vehicle indicated in the desired condition information (S102). Subsequently, the difficulty level calculating unit 216 determines whether or not the reservation result information including the reservation accepting record in which one of locations within the set area is set as the reserved location for riding in a vehicle is stored in the storage apparatus 202 (S104).

Then, when such reservation result information is stored in the storage apparatus 202 (S104: Yes), the difficulty level calculating unit 216 calculates an index value based on the reservation accepting record for each predetermined time slot for each of the predetermined locations within the above-described set area (S106). Here, the index value based on the reservation accepting record is, for example, the above-described number of persons who make reservations, average number of persons who make reservations and/or proportion of persons who make reservations.

Then, the difficulty level calculating unit 216 determines whether or not the matching achievement information including the matching achievement record in which one of locations within the above-described set area is set as the location at which the user rides in a vehicle is stored in the storage apparatus 202 (S108). Then, when such matching achievement information is stored in the storage apparatus 202 (S108: Yes), the difficulty level calculating unit 216 calculates the index value based on the matching achievement record for each predetermined time slot for each of the predetermined locations within the above-described set area (S110). Here, the index value based on the matching achievement record is, for example, the matching achievement probability described above.

Subsequently, the index value output unit 218 transmits and outputs the above-described index value calculated by the difficulty level calculating unit 216 to the mobile terminal 130, or the like, of the user 110, or the like, which is a transmission source of the desired condition information (that is, the desired condition information received in step S100) relating to calculation of the index value (S112).

Meanwhile, in step S104, when the reservation result information as described above is not stored in the storage apparatus 202 (S104: No), the difficulty level calculating unit 216 shifts the processing to step S108.

Further, meanwhile, in step S108, when the matching achievement information as described above is not stored in the storage apparatus 202 (S108: No), the difficulty level calculating unit 216 shifts the processing to step S112.

When transmission of the index value in step S112 is completed, the processing apparatus 200 returns the processing to step S100 and repeats the above-described processing. Note that, when none of the reservation result information and the matching achievement information as described above is stored in the storage apparatus 202, and no index value is calculated at the difficulty level calculating unit 216, in step S112, the processing is shifted to step S100 by the processing apparatus 200 without the index value being output by the index value output unit 218 in step S112.

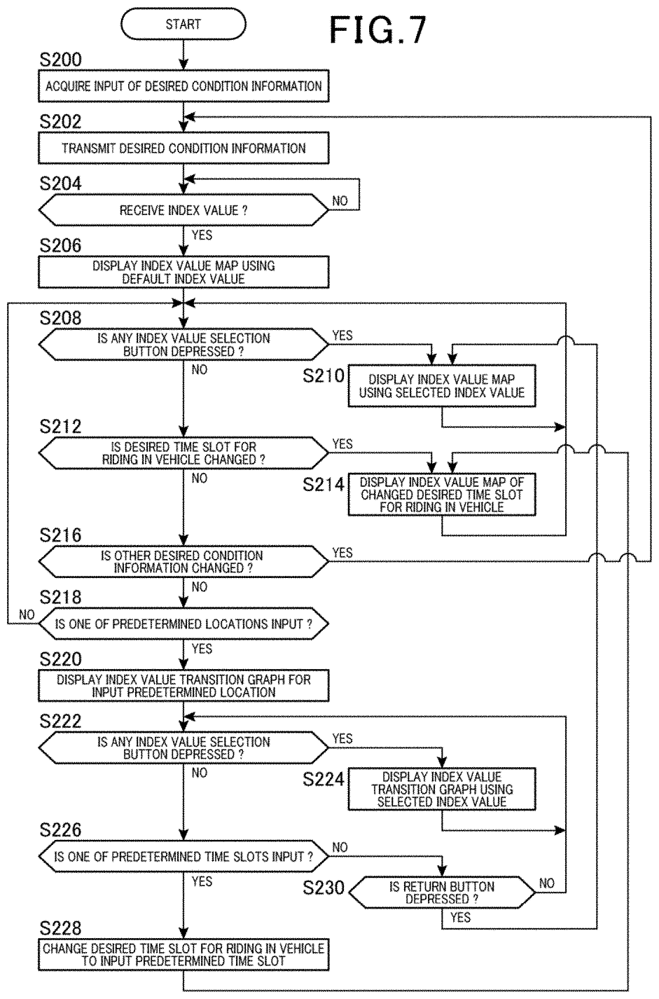

Operation at the mobile terminal 130, or the like, of the user 110, or the like, will be described next. The mobile terminal 130, or the like, can execute the same operation. Therefore, in the following description, operation of the mobile terminal 130, or the like, will be described using an example of the mobile terminal 130. FIG. 7 is a flowchart illustrating procedure of the processing at the mobile terminal 130. The present processing is started when, for example, a dedicated application program is started (executed) at the mobile terminal 130. As a result of this application program being executed, the processing is performed while, for example, display screens 400 and 500 as illustrated in FIG. 4 and FIG. 5 are displayed at the display apparatus 300 of the mobile terminal 130. The present processing started by start of the above-described application program ends when, for example, a reservation button 424 or an end button 426 on the display screen 400 illustrated in FIG. 4 is depressed or when an end button 520 on the display screen 500 illustrated in FIG. 5 is depressed.

In FIG. 7, when the processing is started, the processing apparatus 304 of the mobile terminal 130 acquires input of the desired condition information from the user 110 via the input apparatus 302 (S200). For example, the desired date for riding in a vehicle, the desired location for riding in a vehicle, the desired location for getting off a vehicle and the desired time slot for riding in a vehicle input by the user 110 on the display screen 400 illustrated in FIG. 4 can be used as this desired condition information.

The processing apparatus 304 then transmits the above-described input desired condition information to the vehicle ride-sharing support system 100 via the communication apparatus 308 (S202). Subsequently, the processing apparatus 304 determines whether or not the index value is received from the vehicle ride-sharing support system 100 by the communication apparatus 308 (S204). Then, when the index value is not received (S204: No), the processing apparatus 304 waits until the index value is received.

Meanwhile, when the index value is received (S204: Yes), the processing apparatus 304 displays the index value map at the display apparatus 300 by the index value map display unit 310 using, for example, the matching achievement probability as a default index value (S206). At this time, the index value map display unit 310 can, for example, display the above-described index value map using the index value in the time slot which is currently being selected in the list for inputting a time slot for riding in a vehicle 412 on the display screen 400 illustrated in FIG. 4.

The index value map display unit 310 then, for example, determines whether or not one of the index selection buttons 416, 418, 420 and 422 is depressed on the display screen 400 in FIG. 4 (S208). Then, when one of the index selection buttons 416, 418, 420 and 422 is depressed (S208: Yes), the index value map display unit 310 displays the index value map at the display apparatus 300 using the index value corresponding to the depressed one of the index selection buttons 416, 418, 420 and 422 (S210), returns to step S208 and repeats the processing.

Meanwhile, in step S208, when none of the index selection buttons 416, 418, 420 and 422 is depressed (S208: No), the processing apparatus 304 determines whether or not the desired time slot for riding in a vehicle is changed (S212). This determination can be made in accordance with whether or not selection of the time slot in the list for inputting a time slot for riding in a vehicle 412 is changed on the display screen 400 in FIG. 4.

Then, when the desired time slot for riding in a vehicle is changed (S212: Yes), the index value map display unit 310 returns to step S208 and repeats processing after displaying the index value map using the index value for the changed desired time slot for riding in a vehicle (S214). That is, in response to one of the predetermined time slots being selected and input, the processing apparatus 304 displays the index value map for the input predetermined time slot.

Meanwhile, when the desired time slot for riding in a vehicle is not changed (S212: No), the index value map display unit 310 determines whether or not other desired condition information other than the desired time slot for riding in a vehicle is changed (S216). This determination can be made, for example, in accordance with whether or not input content is changed in one of the box for inputting a desired date for riding in a vehicle 404, the box for inputting a desired location for riding in a vehicle 406, the box for inputting a desired location for getting off a vehicle 408 and the list for inputting a time slot for riding in a vehicle 412 on the display screen 400 in FIG. 4.

Then, when other desired condition information is changed (S216: Yes), the processing apparatus 304 returns to step S202, transmits the changed desired condition information to a vehicle ride-sharing support apparatus 102 and repeats the above-described processing.

Meanwhile, when other desired condition information is not changed (S216: No), the processing apparatus 304 determines whether or not any of the predetermined locations is input (S218). This determination can be made by, for example, determining whether or not any of the predetermined locations at which the index values are displayed is touched on the index value map 414 on the display screen 400 illustrated in FIG. 4.

Then, when none of the predetermined locations is input (S218: No), the processing apparatus 304 returns to step S208 and repeats the processing. On the other hand, when one of the predetermined locations is input (S218: Yes), the processing apparatus 304 displays the index value transition graph for the above-described input predetermined location at the display apparatus 300 by the index value transition display unit 312 (S220). Here, the index value transition display unit 312 can, for example, display the index value transition graph 504 as illustrated in FIG. 5 through the display screen 500 illustrated in FIG. 5. That is, the processing apparatus 304 displays the index value transition graph at the predetermined location in response to one of the predetermined locations being input.

The index value transition display unit 312 then, for example, determines whether or not one of the index selection buttons 508, 510, 512 and 514 is depressed on the display screen 500 in FIG. 5 (S222). Then, when one of the index selection buttons 508, 510, 512 and 514 is depressed (S222: Yes), the index value transition display unit 312 displays the index value transition graph at the display apparatus 300 using the index value corresponding to the depressed one of the index selection buttons 508, 510, 512 and 514 (S224), returns to step S222 and repeats the processing.

On the other hand, in step S218, when none of the index selection buttons 508, 510, 512 and 514 is depressed (S222: No), the processing apparatus 304 determines whether or not one of the predetermined time slots is input (S226). This determination can be made by, for example, determining whether or not a portion of one of the time slots on the time axis 522 is touched on the display screen 500 illustrated in FIG. 5.

Then, when one of the predetermined time slots is input (S226: Yes), the processing apparatus 304 changes the desired time slot for riding in a vehicle to the above-described input predetermined time slot (S228), returns to step S214 and repeats the processing. In this case, the processing apparatus 304 can switch the display screen of the display apparatus 300 from the display screen 500 to the display screen 400, and can display the display screen while inverting and displaying the above-described input time slot at the box for inputting a desired location for riding in a vehicle 406.

Meanwhile, when none of the predetermined time slots is input in step S226 (S226: No), the processing apparatus 304, for example, determines whether or not the return button 518 on the display screen 500 in FIG. 5 is depressed (S230). Then, when the return button 518 is not depressed (S230: No), the processing apparatus 304 returns the processing to step S222.

Meanwhile, when the return button 518 is depressed (S230: Yes), the processing apparatus 304 shifts the processing to step S210, and displays the index value map at the display apparatus 300 by the index value map display unit 310 using, for example, the index value which is currently being selected displayed by the index selection buttons 508, 510, 512 and 514. In this case, the processing apparatus 304 can switch the display screen of the display apparatus 300 from the display screen 500 to the display screen 400, and can display the display screen while inverting and displaying one of the index selection buttons 416, 418, 420 and 422 corresponding to the index value which is currently being selected.

Note that the present invention is not limited to the configuration of the above-described embodiment, and can be implemented in various modes within a scope not deviating from the gist of the present invention.

For example, while, in the vehicle ride-sharing support system 100 in the above-described embodiment, the index value output unit 218 outputs the index value calculated by the difficulty level calculating unit 216 as it is to the mobile terminal 130, or the like, and the index value map and the index value transition graph are generated and displayed at the mobile terminal 130, or the like, the present invention is not limited to this. For example, the index value output unit 218 of the vehicle ride-sharing support system 100 may have the above-described function of generating the index value map and the above-described function of generating the index value transition graph of the processing apparatus 304 of the mobile terminal 130.

In this case, when the mobile terminal 130, or the like, acquires designation of one predetermined location or input of one predetermined time slot through the display screens 400 and 500 in FIG. 4 and FIG. 5, the mobile terminal 130, or the like, can transmit these input to the vehicle ride-sharing support system 100. The index value output unit 218 generates information of a map (for example, map data) in which display in accordance with the index value or a magnitude of the index value calculated for each of the predetermined locations for one predetermined time slot is displayed at a position on the map corresponding to each of the predetermined locations, for example, when receiving input of the one predetermined time slot. Then, the index value output unit 218 can output the generated information of the map to the mobile terminal 130, or the like, which is the user terminal apparatus of the user 110, or the like, from which the desired condition information is acquired.

Alternatively, the index value output unit 218 may, for example, generate transition information for generating a diagram indicating transition of the index value calculated for one predetermined location for each predetermined time slot, for example, when receiving input of the one predetermined location, and may output the transition information to the mobile terminal 130, or the like, which is the user terminal apparatus of the user 110, or the like, from which the desired condition information is acquired. Here, the transition information can be configured with, for example, information (for example, a table) which associates the respective predetermined time slots with the respective index values for each predetermined time slot, which is calculated for the above-described one input predetermined location.

Further, while, in the above-described vehicle ride-sharing support system 100, the difficulty level calculating unit 216 calculates the index value without using information of the desired location for getting off a vehicle included in the desired condition information, the present invention is not limited to this. For example, the difficulty level calculating unit 216 may calculate the index value based on the reservation accepting record and the index value based on the matching achievement record respectively using the reservation accepting record including the desired location for getting off a vehicle included in the desired condition information as the location where the user gets off a vehicle, and the matching achievement record including the desired location for getting off a vehicle as the route through which the user rides in a vehicle. By this means, it is possible to guide the user to a location and/or a time slot in which matching with the vehicle for ride-sharing which heads for the desired location for getting off a vehicle is more likely to be achieved.

Further, while, the above-described vehicle ride-sharing support system 100 is configured as one apparatus, for example, one server connected to the network 104, the present invention is not limited to this. The vehicle ride-sharing support system 100 can be configured with, for example, a plurality of apparatuses respectively having functions obtained by dividing the function of the vehicle ride-sharing support system 100. For example, the vehicle ride-sharing support system 100 can be configured with a first apparatus having functions of the reservation information acquiring unit 212 and the achievement information acquiring unit 214, and a second apparatus having other functions. The above-described first apparatus and second apparatus can be connected to each other, for example, via the network 104 or without involving the network 104 so as to be able to perform communication. In this case, the reservation result information and the matching achievement information acquired by the first apparatus can be provided to the second apparatus, for example, via the network 104.

As described above, the vehicle ride-sharing support system 100 according to the above-described embodiment supports matching between a user who desires ride-sharing of a vehicle and a vehicle for ride-sharing. The vehicle ride-sharing support system 100 includes a condition information acquiring unit 210 which acquires desired condition information from the mobile terminal 130, or the like, which is a user terminal apparatus utilized by the user 110, or the like, the desired condition information including a desired location for riding in a vehicle and a desired time slot for riding in a vehicle, which are desired by the user 110, or the like, regarding a vehicle for ride-sharing. Further, the vehicle ride-sharing support system 100 includes a reservation information acquiring unit 212 which acquires and stores a reservation accepting record for each matching reservation request, the reservation accepting record being indicative of the following indicated in a matching reservation request: a reserved location for riding in a vehicle; a reserved date for riding in a vehicle; and a reserved time slot for riding in a vehicle, the matching reservation request being transmitted from the mobile terminal 130, or the like, of the user 110, or the like for requesting reservation of matching with a vehicle for ride-sharing. Further, the vehicle ride-sharing support system 100 includes a difficulty level calculating unit 216 which calculates, on the basis of the stored past reservation accepting record, an index value of an index representing a difficulty level of achievement of the above-described matching for each predetermined time slot including the desired time slot for riding in a vehicle for each of the predetermined locations in an area within a predetermined distance range including the desired location for riding in a vehicle.

According to this configuration, the index value for each predetermined time slot including the desired time slot for riding in a vehicle is output for each of the predetermined locations within an area having a predetermined size including the desired location for riding in a vehicle in accordance with the number of persons who make reservations in the past and a frequency of reservation. Therefore, the user 110, or the like, can adjust the desired time for riding in a vehicle and the desired location for riding in a vehicle by referring to the index values based on the past reservations situations through the mobile terminal 130, or the like, so that it is possible to increase a possibility of achievement of matching with the vehicle for ride-sharing.

Further, in the vehicle ride-sharing support system 100, the above-described index is the number of persons who make reservations while the predetermined location is set as the reserved location for riding in a vehicle and the predetermined time slot is set as the reserved time slot for riding in a vehicle in the past predetermined period. According to this configuration, the user 110, or the like, can recognize a location and a time slot in which reservations are made with high frequency, can adjust the desired location for riding in a vehicle and the desired time slot for riding in a vehicle to these location and time slot, so that it is possible to increase a possibility of achievement of matching with the vehicle for ride-sharing.

Further, in the vehicle ride-sharing support system 100, the above-described index is the average number of persons who make reservations per day of the number of persons who make reservations while the above-described predetermined location is set as the reserved location for riding in a vehicle and the above-described predetermined time slot is set as the reserved time slot for riding in a vehicle in the past predetermined period. According to this configuration, because the average number of persons who make reservations per day is presented, the user 110, or the like, can easily recognize a possibility of achievement of matching in the time slot per day.

Further, in the vehicle ride-sharing support system 100, the above-described index is a proportion of the number of persons who make reservations while the above-described predetermined time slot is set as the reserved time slot for riding in a vehicle to the persons who make reservations while the above-described predetermined location is set as the reserved location for riding in a vehicle in the past predetermined period or at the past predetermined date. According to this configuration, the user 110, or the like, can easily recognize whether a possibility of achievement of matching is high or low in each time slot in one day.

Further, the vehicle ride-sharing support system 100 includes an achievement information acquiring unit which acquires and stores a matching achievement record indicating a location where the user rides in a vehicle, a date at which the user rides in a vehicle and a time slot in which the user rides in a vehicle for each vehicle for ride-sharing for which matching with the user 110, or the like, is achieved. Further, the difficulty level calculating unit 216 calculates the above-described index value on the basis of the above-described stored matching achievement record. According to this configuration, the index value for each predetermined time slot including the desired time slot for riding in a vehicle is output for each of the predetermined locations within an area having a predetermined size including the desired location for riding in a vehicle, in accordance with the number of cases of achievement of matching in the past. Therefore, the user 110, or the like, can adjust the desired time for riding in a vehicle and the desired location for riding in a vehicle by referring to the index values based on these past matching achievement situations through the mobile terminal 130, or the like, so that it is possible to increase a possibility of achievement of matching with the vehicle for ride-sharing.

Further, in the vehicle ride-sharing support system 100, the index calculated on the basis of the above-described matching achievement record is a matching achievement probability indicating a proportion of the number of days in which matching is achieved in the above-described predetermined time slot at the above-described predetermined location within a predetermined period to the number of days in the past predetermined period. According to this configuration, the user 110, or the like, can adjust the desired location for riding in a vehicle and the desired time slot for riding in a vehicle on the basis of the past matching achievement probability which directly indicates a possibility of achievement of matching, so that it is possible to increase a possibility of matching with the vehicle for ride-sharing.

Further, the vehicle ride-sharing support system 100 includes an index value output unit which outputs the above-described calculated index value for each of the above-described predetermined time slot for each of the above-described predetermined locations to the mobile terminal 130, or the like, of the user 110, or the like, from which the above-described desired condition information is acquired. According to this configuration, because the mobile terminal 130, or the like, can display the above-described index value in an arbitrary mode which can be easily utilized by the user 110, or the like, it is possible to further increase user-friendliness by, for example, performing display, or the like, in accordance with preference of the user 110, or the like.

Further, the mobile terminal 130, or the like, which is the user terminal apparatus which receives the above-described calculated index value from the vehicle ride-sharing support system 100 of the present invention includes the input apparatus 302 which accepts input from the user 110, or the like, the display apparatus 300, and the processing apparatus 304. Further, the processing apparatus 304 displays the index value map which is a map in which display in accordance with the above-described calculated index value or a magnitude of the index value is indicated at a position corresponding to the above-described predetermined location, at the display apparatus 300 in response to one of the above-described predetermined time slots being input from the user 110, or the like.

According to this configuration, the user 110, or the like, can make determination as to change of the desired location for riding in a vehicle, or the like, by causing the index value map regarding a desired time slot to be immediately displayed at the display apparatus 300 without the mobile terminal 130, or the like, and the vehicle ride-sharing support system 100 performing communication every time.

Further, the mobile terminal 130, or the like, which is the user terminal apparatus which receives the above-described calculated index value from the vehicle ride-sharing support system 100 of the present invention includes the input apparatus 302 which accepts input from the user 110, or the like, the display apparatus 300, and the processing apparatus 304. The processing apparatus 304 displays the index value transition graph which is a diagram indicating transition of the above-described calculated index value at the predetermined location along the above-described predetermined time slots at the display apparatus 300 in response to one of the above-described predetermined locations being input from the user 110, or the like.

According to this configuration, the user 110, or the like, can make a determination as to change of the desired time slot for riding in a vehicle, or the like, by causing the index value map for the desired time slot to be immediately displayed at the display apparatus 300 without the mobile terminal 130, or the like, and the vehicle ride-sharing support system 100 performing communication every time.

Further, the index value output unit 218 of the vehicle ride-sharing support system 100 may generate map information for creating an index value map in which display in accordance with the above-described index value or a magnitude of the index value calculated for each of the above-described predetermined locations for the above-described one predetermined time slot is displayed at a position on the map corresponding to each of the above-described predetermined locations. The index value output unit 218 can output the generated map information to the mobile terminal 130, or the like, of the user 110, or the like, from which the above-described desired condition information is acquired.

Alternatively, the index value output unit 218 of the vehicle ride-sharing support system 100 may generate transition information for generating the index value transition graph which is a diagram indicating transition of the above-described index value calculated for the above-described one predetermined location, for each of the above-described predetermined time slots. The index value output unit 218 can output the transition information to the mobile terminal 130, or the like, of the user 110, or the like, from which the above-described desired condition information is acquired.

According to these configurations, processing for displaying the index value at the mobile terminal 130, or the like, is reduced.

### REFERENCE SIGNS LIST

100 vehicle ride-sharing support system
104 network
106 vehicle ride-sharing matching apparatus
110, 112, 114, 116, 118, 120, 122, 124, 126, 128 user
130, 132, 134, 136, 138, 140, 142, 144, 146, 148 mobile terminal
150 company
152 department store
154 park
156, 452 station
158 hotel
160, 162 vehicle for ride-sharing
200, 304 processing apparatus
202, 306 storage apparatus
204, 308 communication apparatus
210 condition information acquiring unit
212 reservation information acquiring unit
214 achievement information acquiring unit
216 difficulty level calculating unit
218 index value output unit
300 display apparatus
302 input apparatus
310 index value map display unit
312 index value transition display unit
400, 500 display screen
402, 502 title
404 box for inputting desired date for riding in vehicle
408 box for inputting desired location for getting off vehicle
410 map display button
412 list for inputting time slot for riding in vehicle
414 index value map
416, 418, 420, 422, 508, 510, 512, 514 index selection button
424 reservation button
426, 520 end button
430, 432, 434, 436, 438, 440, 442, 444, 446 black circle
450 mark of desired location for riding in vehicle
452 station
504 index value transition graph
506 text of desired location for riding in vehicle
516 marker
518 return button
522 time axis

What is claimed is:

1. A vehicle ride-sharing support system which supports matching between a user who desires ride-sharing of a vehicle and a vehicle for ride-sharing, the vehicle ride-sharing support system comprising:
a condition information acquiring unit configured to acquire desired condition information from a user terminal apparatus utilized by the user, the desired condition information including a desired location for riding in a vehicle and a desired time slot for riding in a vehicle, the desired location and the desired time slot being desired by the user regarding a vehicle for ride-sharing;
a reservation information acquiring unit configured to acquire and store a reservation accepting record for each matching reservation request, the reservation accepting record being indicative of the following indicated in a matching reservation request: a reserved location for riding in a vehicle; a reserved date for riding in a vehicle; and a reserved time slot for riding in a vehicle, the matching reservation request being transmitted from the user terminal apparatus of the user for requesting reservation of the matching; and
a difficulty level calculating unit configured to calculate, on a basis of the stored past reservation accepting record, an index value of an index representing a difficulty level of achievement of the matching for each predetermined time slot including the desired time slot for riding in a vehicle for each of predetermined locations in an area within a predetermined distance range including the desired location for riding in a vehicle.

2. The vehicle ride-sharing support system according to claim 1,
wherein the index is a number of persons who make reservations while the predetermined location is set as the reserved location for riding in a vehicle, and the predetermined time slot is set as the reserved time slot for riding in a vehicle, in a past predetermined period.

3. The vehicle ride-sharing support system according to claim 1,
wherein the index is an average number of persons who make reservations per day of a number of persons who make reservations while the predetermined location is set as the reserved location for riding in a vehicle, and the predetermined time slot is set as the reserved time slot for riding in a vehicle, in a past predetermined period.

4. The vehicle ride-sharing support system according to claim 1,
wherein the index is a proportion of a number of persons who make reservations while the predetermined time slot is set as the reserved time slot for riding in a vehicle to persons who make reservations while the predetermined location is set as the reserved location for riding in a vehicle, in a past predetermined period or at a past predetermined date.

5. A vehicle ride-sharing support system which supports matching between a vehicle for ride-sharing and a user who desires ride-sharing of a vehicle, the vehicle ride-sharing support system comprising:
a condition information acquiring unit configured to acquire desired condition information from a user terminal apparatus utilized by the user, the desired condition information including a desired location for riding in a vehicle and a desired time slot for riding in a vehicle, the desired location and the desired time slot being desired by the user regarding a vehicle for ride-sharing;
an achievement information acquiring unit configured to acquire and store a matching achievement record indicating a location where the user rides in a vehicle, a date at which the user rides in a vehicle, and a time slot in which the user rides in a vehicle for each vehicle for ride-sharing for which the matching is achieved; and
a difficulty level calculating unit configured to calculate, on a basis of the stored matching achievement record, an index value of an index representing a difficulty level of achievement of the matching for each predetermined time slot including the desired time slot for riding in a vehicle for each of predetermined locations in an area within a predetermined distance range including the desired location for riding in a vehicle.

6. The vehicle ride-sharing support system according to claim 1,
wherein the index is a matching achievement probability indicating a proportion of a number of days in which the matching is achieved in the predetermined time slot, at the predetermined location, within a predetermined period, to a number of days in the past predetermined period.

7. The vehicle ride-sharing support system according to claim 1, further comprising:
an index value output unit configured to output the calculated index value for each predetermined time slot for each of the predetermined locations to the user terminal apparatus of the user, from which the desired condition information is acquired.

8. A user terminal apparatus which receives the calculated index value from the vehicle ride-sharing support system according to claim 7, the user terminal apparatus comprising:
an input apparatus configured to accept input from the user;
a display apparatus; and
a processing apparatus,
wherein the processing apparatus displays a map in which display in accordance with the calculated index value or a magnitude of the index value is indicated at a position corresponding to the predetermined location, at the display apparatus in response to one of the predetermined time slots being input from the user.

9. A user terminal apparatus which receives the calculated index value from the vehicle ride-sharing support system according to claim 7, the user terminal apparatus comprising:
an input apparatus configured to accept input from the user;
a display apparatus; and
a processing apparatus,
wherein the processing apparatus displays a diagram indicating transition of the calculated index value along the predetermined time slots at the predetermined location, at the display apparatus in response to one of the predetermined locations being input from the user.

10. The vehicle ride-sharing support system according to claim 1, further comprising:
an index value output unit configured to generate map information in which display in accordance with the index value calculated for each of the predetermined locations or a magnitude of the index value for the one predetermined time slot is displayed at positions on a map respectively corresponding to the predetermined locations, and output the generated map information to the user terminal apparatus of the user, from which the desired condition information is acquired.

11. The vehicle ride-sharing support system according to claim 1, further comprising:
an index value output unit configured to generate transition information for generating a diagram indicating transition of the index value calculated for the one predetermined location for each predetermined time slot, and output the transition information to the user terminal apparatus of the user, from which the desired condition information is acquired.
